(19) United States
(12) Patent Application Publication
(10) Pub. No.: US 2008/0056327 A1
(43) Pub. Date: Mar. 6, 2008

(54) METHOD AND SYSTEM FOR PREDICTIVE ELECTRODE LOWERING IN A FURNACE

(75) Inventor: Terry Gerritsen, Oakville (CA)

Correspondence Address: BERESKIN AND PARR, 40 KING STREET WEST, BOX 401, TORONTO, ON, M5H 3Y2, US

(73) Assignee: HATCH LTD., Mississauga (CA)

(21) Appl. No.: 11/738,901

(22) Filed: Apr. 23, 2007

Related U.S. Application Data
(60) Provisional application No. 60/824,009, filed on Aug. 30, 2006.

(51) Int. Cl. H05B 7/10; F27D 11/10

(52) U.S. Cl. 373/102

(57) ABSTRACT

Aspects of the invention relate to methods and systems for predictive electrode lowering in an electric furnace. According to one aspect, there is provided a method comprising: monitoring an operating parameter of a variable reactance circuit; comparing the operating parameter with a threshold value; and lowering an electrode coupled to the variable reactance circuit if the operating parameter meets or passes the threshold value. The operating parameter may be a current threshold. The current threshold may be determined based on at least one of: a predetermined proportion of an expected total current through the variable reactance circuit; a primary supply voltage; a rated reactance value of the parallel inductor; and a target power factor. The current threshold may be in the range between about 10% and 60% of the expected total current through the variable reactance circuit and may vary proportionally with the primary supply voltage.

### CROSS-REFERENCE TO RELATED APPLICATIONS

This application claims the benefit of U.S. Provisional Patent Application Ser. No. 60/824,009 filed on Aug. 30, 2006, the entire content of which is hereby incorporated by reference.

### TECHNICAL FIELD

Aspects of the invention relate to methods and systems for predictively lowering an electrode in an electric furnace. In particular, the lowering is done to mitigate loss of power to the furnace.

### BACKGROUND

Time varying loads can result in unwanted disturbances to a power supply network. An example of such a load is an alternating current (AC) electric arc furnace, which is commonly used to melt and re-melt ferrous materials such as steel, and to smelt non-ferrous materials. Such furnaces generally use high power arcs to generate heat energy, consequently the voltage, current and power drawn by an arc furnace tends to fluctuate, causing disturbances to both the melting process and to the power supply network. These disturbances can result in inefficiencies, increased equipment wear, disturbances to the power supply network, or in extreme cases damage to the arc furnace itself.

One possible solution to the power fluctuations is to install a device such as a predictive line controller, which consists of a thyristor controlled reactor in series with the arc electrode. The predictive line controller functions as a dynamically controlled series reactor that uses predictive software to stabilize the power drawn by an electric arc furnace. A control system of the predictive line controller provides co-coordinated control of thyristor firing, transformer tap position and electrode positioning. As the arc furnace load fluctuates, the impedance at the electric furnace transformer is measured. The control system adjusts the firing angle of the thyristors to compensate for the load fluctuations and to stabilize the furnace power.

The predictive line controller adds flexibility to the operation of the electric furnace, through the benefit of having variable reactance. The predictive line controller generally limits the number of upward power swings beyond the power set point and thus helps to maintain an average power closer to the power set point. However, downward power swings, such as those that result from a loss of arc, are more difficult for the predictive line controller to compensate for, at least in part because of the relatively slow movement rate of the electrode when electrode repositioning is required to compensate for loss of power.

FIG. 4 is a graph showing an example of three-phase arc furnace power readings, illustrating the difference in furnace power between when the predictive line controller is used and when it is not used. For the first sixty minutes of operation of the arc furnace, the predictive line controller was not used; and as is evident from the graph of FIG. 4, the fluctuations in power are substantial in both the positive and negative directions. Between 60 minutes and 120 minutes, the predictive line controller was used to limit power fluctuations, and it can be seen that the fluctuations were dramatically reduced. In particular, power fluctuations above sixty megawatts were substantially non-existent. However, some power fluctuations below sixty megawatts still occurred, some in the order of about ten megawatts.

The described embodiments attempt to address or ameliorate one or more shortcomings of existing control systems for arc furnaces, or to at least provide a useful alternative thereto.

### SUMMARY

Some aspects of the invention relate to a method of predictive electrode lowering in an electric furnace, comprising: monitoring an operating parameter of a variable reactance circuit; comparing the operating parameter with a threshold value; and lowering an electrode coupled to the variable reactance circuit if the operating parameter meets or passes the threshold value.

The variable reactance circuit may be positioned in a power supply circuit intermediate a power supply and the electrode. A transformer may be positioned in the power supply circuit intermediate the variable reactance circuit and the electrode. The operating parameter may be a current threshold. The current threshold may be determined based on at least one of: a predetermined proportion of an expected total current through the variable reactance circuit; a primary supply voltage; a rated reactance value of the parallel inductor; and a target power factor. The current threshold may be in the range between about 10% and 60% of the expected total current through the variable reactance circuit and may vary proportionally with the primary supply voltage. The monitoring may comprise monitoring an operating parameter of a sub-circuit of the variable reactance circuit.

The current switching circuit may comprise a pair of thyristors. The operating parameter may be a gating angle of the thyristors. The threshold value may be in the range between about 80° and 170°. The sub-circuit may comprise a parallel inductor and the operating parameter may be a current through the parallel inductor. The threshold value may be a current threshold value. Alternatively, the operating parameter may be a voltage across the parallel inductor. The sub-circuit may comprise a series reactor.

The electric furnace may be a multi-phase furnace and the method may be performed for each phase of the furnace. The electrode may be a part of an electrode pair for a power supply phase and the lowering may comprise lowering the electrode pair. The electric furnace may be an AC electric arc furnace. The threshold value may be a first threshold value and the method may further comprise monitoring the operating parameter during the lowering, comparing the operating parameter to a second threshold value and ceasing the lowering if the operating parameter exceeds the second threshold value. The second threshold value may be higher than the first threshold value.

Other aspects relate to a system for predictive lowering of an electrode in an electric furnace, comprising: a variable reactance circuit electrically coupled to the electrode for regulating current to the electrode from a power supply; a sensor for sensing an operating parameter of the variable reactance circuit; and an electrode position controller configured to receive a sensor signal corresponding to the operating parameter from the sensor, to compare the operating parameter to a threshold value and to cause the electrode to be lowered if the operating parameter meets or passes the threshold value.

Other aspects of the invention relate to a method of predictive electrode lowering in an electric furnace, comprising: monitoring current through a parallel inductor in a variable reactance circuit; comparing the current with a current threshold; and lowering an electrode coupled to the variable reactance circuit if the current is at or below the current threshold.

Further aspects relate to a system for predictive lowering of an electrode in an electric furnace, comprising: a variable reactance circuit electrically coupled to the electrode for regulating current to the electrode from a power supply, the variable reactance circuit having a parallel inductor; a sensor for sensing a current through the parallel inductor; and an electrode position controller configured to receive a sensor signal corresponding to the current from the sensor, to compare the current to a current threshold and to cause the electrode to be lowered if the current is at or below the current threshold.

Still further aspects relate to computer readable storage storing program instructions which, when executed by one or more processors in a furnace system, cause the furnace system to perform the methods described above.

### BRIEF DESCRIPTION OF THE DRAWINGS

Embodiments are described in further detail below, by way of example, with reference to the accompanying drawings, in which:

FIG. 1 is a single line diagram of a control system for a power supply to an arc furnace;

FIG. 2 is a block diagram of an electrode position controller of the control system;

FIG. 3 is a flowchart of a method of predictively controlling electrode movement in an arc furnace; and

FIG. 4 is a graph of three-phase arc furnace power readings versus time, illustrating the effect of use of a predictive line controller on power fluctuations.

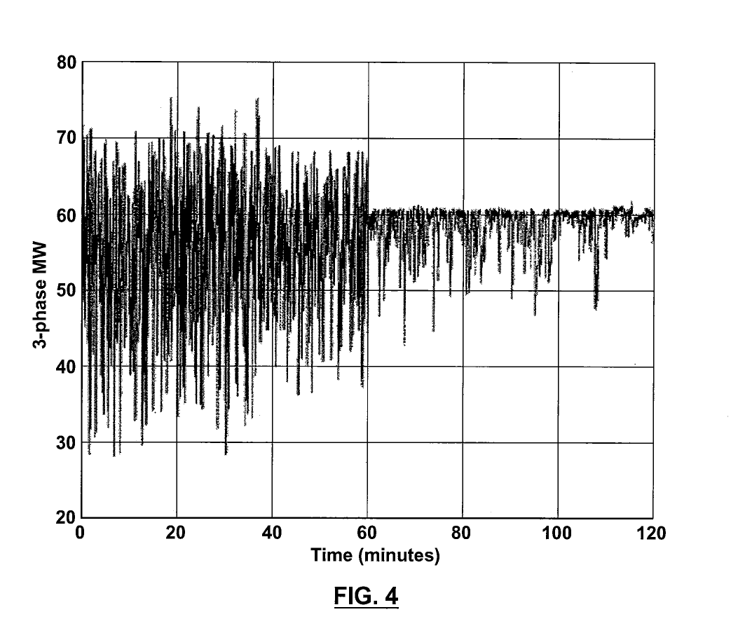

### DETAILED DESCRIPTION

Embodiments described herein generally relate to methods and systems for predictive lowering of an electrode in an electric furnace, such as an AC electric arc furnace. The described systems and methods may be characterized as an improvement of the systems and methods described in co-owned U.S. Pat. No. 6,603,795 to Ma et al. entitled “Power Control System for AC Electric Arc Furnace,” the entire content of which is hereby incorporated by reference.

The described embodiments employ a structure similar to the predictive line controller described above, although with a modified sensing and control paradigm directed to reducing the number and magnitude of the downward power deviations from the power set point. According to the described embodiments, this is done by lowering the electrode in anticipation, or upon early detection, of a power drop.

While the embodiments are described by way of specific example in relation to electric arc furnaces, the invention is not limited in application to electric arc furnaces.

While some embodiments described herein relate to three-phase, three-wire electric arc furnaces with one electrode per phase, other embodiments are applicable to furnaces having only one electrode, whether arcing or non-arcing and whether DC or AC, or other numbers of electrodes. Further embodiments may be applied to furnaces having two electrodes per phase of a multi-phase power supply. For example, some embodiments may be applied to a three-phase furnace having six electrodes.

It should be understood that for every kind of electrical furnace configuration, it is necessary to provide a return path for the current passing through the electrode. This may be through the conductors of the three phase power supply or it may be through a dedicated conductor separate to the supply conductors. In the case of a one electrode furnace, the return path of the current may be through a fixed conductive medium in electrical contact with the working material in the furnace.

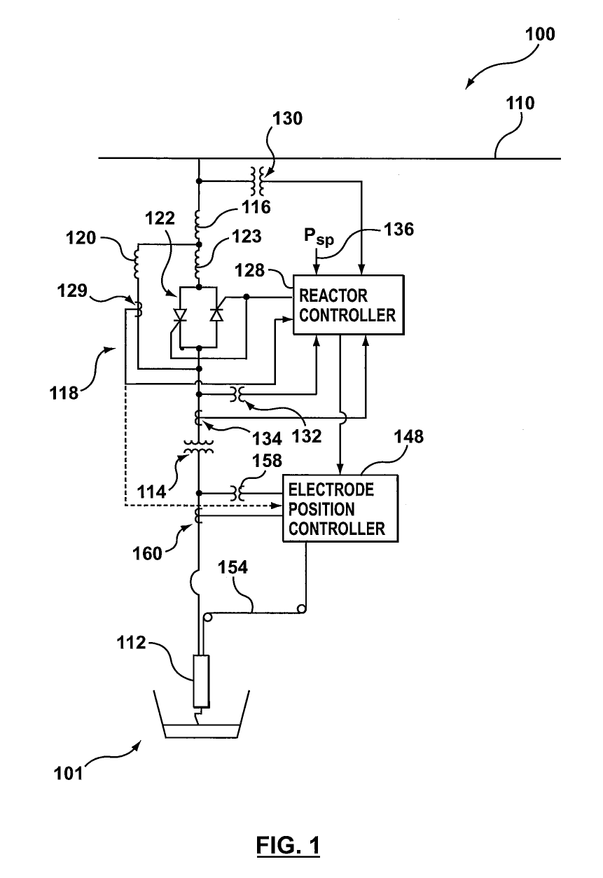

Reference is now made to FIG. 1, which shows a schematic diagram of a power control system 100 in accordance with some embodiments. The power control system 100 may include one or more furnaces (or loads) 101. Only a single-phase embodiment is illustrated in FIG. 1 for the sake of simplicity of description; however, the functions and operating principles of the single-phase control described and illustrated may be extended to multi-phase systems.

Each furnace 101 (each phase in the case of a three-phase embodiment) includes an electrode 112 coupled to the secondary side of a furnace transformer 114. The primary side of the furnace transformer 114 is coupled to a supply bus power source 110 that supplies a primary supply voltage through a fixed series reactance 116 in series with a variable reactance circuit 118 (also called a variable reactor). Thus, electrode 112 is indirectly coupled to variable reactance circuit 118. Variable reactor 118 may alternatively be placed on the secondary side of transformer 114 so as to be more directly coupled to electrode 112.

In one embodiment, the variable reactor 118 includes a parallel inductor 120 (also called a parallel reactor) connected in parallel with a series combination of a current limiting inductor 123 (also called a current limiting reactor) and a thyristor switch 122. The thyristor switch 122 includes a pair of thyristors arranged in opposite polarity to each other.

In alternative embodiments, variable reactor 118 may substitute the thyristor switch 122 with an alternative circuit configuration for controlling current through the series limb of variable reactor 118. For example, instead of thyristor switch 122, a variable resistor, controllable diodes, MOSFETs, BJTs, isolated gate bipolar transistors (IGBTs) or an electromechanical switch or relay configuration may be used. Alternatively, the thyristor switch 122 may use gate turn-off (GTO) thyristors.

In embodiments of variable reactor 118 having alternative current controlling configurations to thyristor switch 122, the circuit configuration, including parallel inductor 120 and series reactance 116, remains the same. Thus, thyristor switch 122, and possibly current limiting inductor 123, may be replaced with an equivalent current control element or sub-circuit that is controllable by a reactor controller 128. However, for simplicity of description, the exemplary embodiments are described only with reference to thyristor switch 122.

Each furnace 101 (or phase) includes a variable reactor control system, which includes a first voltage transformer 130 for measuring the primary supply voltage on the supply side of the variable reactor 118, a second transformer 132 for measuring the voltage on the furnace side of the variable reactor 118, a current transformer 134 for measuring the main current flowing to the furnace transformer 114, and a reactor controller 128.

The reactor controller 128 receives voltage and current measurement information from the first and second voltage transformers 130, 132, the current transformer 134, and a desired power set-point input 136. The reactor controller 128 controls the variable reactor 118, and thyristor switch 122 (or its equivalent) in particular, based upon calculations performed using such information.

The reactor controller 128 may comprise a programmable processing device (not shown), such as a programmable logic controller (PLC), process automation controller (PAC) or computer, comprising a processor, such as a digital signal processor, microcontroller, microprocessor, or application-specific integrated circuit (ASIC).

The reactor controller 128 operates under stored program control based on stored computer program instructions. The stored computer program instructions implement the functions and operations described herein and are stored in a non-volatile memory element (not shown), such as firmware, accessible to the processing device. The suitable programming of the reactor controller 128 to implement the functions or operations described herein will be within the understanding of one of ordinary skill in the art. Other forms of the reactor controller 128 may be implemented to perform the described functions using other combinations of hardware and/or software.

The reactor controller 128 controls the reactance of the variable reactor 118 by adjusting the firing angles of thyristors 122, thereby increasing or decreasing the current through the inductor 123. Based on ongoing current and voltage readings acquired from the first and second voltage transformers 130, 132, and the current transformer 134, the reactor controller 128 gates (i.e. varies the gating angles of) the thyristors 122 to vary reactance in order to regulate power swings or unbalances in the arc furnace 101 about the desired power set-point 136 that result from arc impedance fluctuations.

Each furnace 101 (or phase) further includes an electrode position controller 148 that receives inputs from a voltage transformer 158 and a current transformer 160 on the secondary side of the furnace transformer 114. The electrode position controller 148 is operatively coupled to an electrode movement system 154 for adjusting the height of the electrode 112, and thereby adjusting the arc impedance. The electrode position controller 148 may therefore adjust the height of the electrode 112 in order to compensate for changes in the arc impedance. The response time of the electrode positioning system is typically at least one order of magnitude slower than the variable reactance system.

The reactor controller 128 maintains the furnace power set-point level, despite the lowering of the electrode 112 and the consequent reduction in the arc impedance, by adjusting the reactance of the variable reactor 118 and thus preventing the power from straying too far from the power set-point. The anticipating action of the electrode position controller 148 positions the electrode 112 at such a height as to mitigate against further current (and hence power) drops. At the same time, the reactor controller 128 maintains the furnace power set-point through adjustments to the variable reactor 118.

While the electrode 112 is being positioned, the reactor controller 128 maintains the power and/or current set-point through adjustments to the variable reactor 118. The electrode position controller 148 determines whether or not the electrode 112 has reached an appropriate position, as described below. The adjustment of the electrode position is a corrective action that typically requires more time than the adjustment of the variable reactor 118, which can occur with each half cycle of the supply voltage.

The thyristors 122, along with control software executed by the reactor controller 128, control the amount of reactance in the power supply line to the electrode 112. When the power supply line requires more reactance, the thyristors 122 are forced by reactor controller 128 to close, forcing current through the parallel reactor 120, and consequently creating more reactance in the power supply line. Conversely, when there is no current flowing through the parallel reactor 120, it implies that the thyristors 122 are fully open, creating a short circuit across the thyristors 122. The short circuit creates a path of least resistance and allows all of the current to flow through the thyristors 122, rather than through parallel reactor 120.

For the reactor controller 128 to be able to control power through the power supply line to electrode 112, at least some current must be flowing in the parallel reactor 128. The amount of reactance required in the power supply line at any given time depends on the measured resistance of the arc between the electrode 112 and the working material in furnace 101. The arc resistance may be controlled to some extent by the position of the electrode 112.

As electrode 112 is large, heavy and moves slowly, it can generally not be moved quickly enough to fully compensate for rapid changes in the arc conditions. Accordingly, reactor controller 128 and/or electrode position controller 148 monitor the current levels through the parallel reactor 120 or another sub-circuit of variable reactance circuit 118 and, if the current level (or other equivalently indicative operating parameter) drops below a calculated threshold, electrode 112 is lowered to keep the reactance of the power supply line within the range of control of reactor controller 128. This means that the electrode 112 can be lowered before thyristors 122 end up becoming fully closed. Thus, control system 100 can effectively predict when the electrode will need to be moved downwardly to avoid or minimize loss of power control by reactor controller 128.

As shown in FIG. 1, a sensor, such as a current transformer 129, may be positioned to sense the current through the sub-circuit of variable reactance circuit 118 that has the parallel reactor 120. The output of current transformer 129 is fed into reactor controller 128 or alternatively into electrode position controller 148. Sensing the current level through parallel reactor 120 enables the system 100 to determine whether the thyristors 122 are close to a fully conducting state, which would mean that the reactor controller 128 cannot as effectively regulate current and power in the supply line to electrode 112.

The current level sensed at current transformer 129 is received as an input to reactor controller 128, which passes the signal corresponding to the received current level to electrode position controller 148. The electrode position controller 148 then determines whether the sensed current level is at or below a calculated current threshold.

The current threshold value, Iₓ, is calculated according to the equation below:

$${I}_{x} = α ( \frac{{V}^{2} ( \sqrt{1 - {pf}^{2}} ) pf - {PX}_{fixed}}{\sqrt{3} V pf {X}_{R}} ) \qquad ( 1 )$$

where α is a proportionality constant, P is the power setpoint, V is the primary supply voltage, pf is a target power factor of the power supply line to electrode 112, X_{R} is the nameplate (rated) reactance value of the parallel reactor 120, x_{fixed} is the value of the fixed reactance in the circuit, including series reactance 116, the transformer reactance and the bus reactance.

Equation (1) is suitable for calculating separate current threshold values on each phase of a three-electrode, three-phase electric arc furnace. The same equation can be used to determine suitable separate current threshold values for a six-electrode, three-phase electric arc furnace, except that in such a case, the V² term in equation (1) must be multiplied by a factor of three. For the six-electrode configuration, two electrodes are coupled to each phase and are moved together when electrode movement is required.

The proportionality constant a can be adjusted and serves to set the current threshold value to a certain proportion (or percentage) of the expected current through the variable reactance circuit 118 when operating at target power. Alternatively, the proportionality constant α may set the current threshold value to a proportion of the highest current for which the parallel reactor 120 is designed.

Although the power factor of a load normally varies as a function of the phase difference between the voltage and current, the power factor pf is, in this case, a target power factor, chosen as a constant between 0 and 1.

In one example, for an expected current through the parallel reactor of about 70% of the total expected current of the variable reactance circuit 118, then if the proportionality constant α is set to 0.5, the current threshold value will be at about 35% of the total expected current through variable reactance circuit 118. For present purposes, the term in brackets in equation (1) may be considered to represent the expected current through parallel reactor 120, as a function of the primary supply voltage V and the rated reactance value of parallel reactor 120. The current threshold may be, for example, between about 10% and 60% of the expected total current through the variable reactance circuit.

While embodiments shown and described in relation to FIG. 1 refer to use of current transformer 129 to sense the current level through the parallel reactor sub-circuit, it should be understood that the parallel reactor current is a representative operating parameter chosen for purposes of illustration. Alternative operating parameters may be used to determine a relative state of control of variable reactor 118 (i.e. how open or closed thyristors 122 are) and may be compared to relevant alternative thresholds for predicting when to lower electrode 112. For example, a current transformer may be used to measure the current through current limiting reactor 123 as the operating parameter. In a further example, the voltage across parallel reactor 120 or current limiting reactor 123 may be measured as the operating parameter. Calculation of appropriate thresholds for such alternative operating parameters will be apparent to those skilled in the art. If the voltage across parallel reactor 120 or series reactor 123 is to be used as the operating parameter, an appropriate voltage measurement device can be used as a sensor for this purpose.

In a further alternative embodiment, the operating parameter used for comparison against a threshold value to determine whether to lower electrode 112 may be the gating angle of thyristors 122. Reactor controller 128 provides control signals to thyristors 122 to control the firing angles thereof and receives a feedback signal from a gating angle sensor circuit (not shown) that indicates a firing angle between 0° and 180°. In a further embodiment, more than one of the described operating parameters may be used for redundancy purposes.

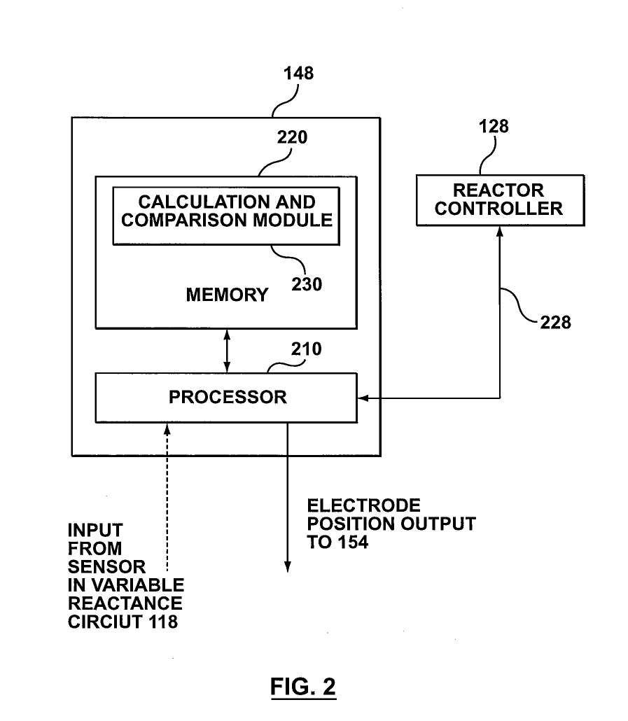

FIG. 2 is a block diagram showing electrode position controller 148 in further detail. Electrode position controller 148 comprises a processor 210 and a memory 220. The memory 220 is accessible to processor 210 and comprises a calculation and comparison module 230. The calculation and comparison module 230 comprises program instructions executable by processor 210 for calculating the current threshold value and comparing it against the current level sensed by current transformer 129 (and received by reactor controller 128). Depending on the result of the comparison of the sensed current level to the current threshold value, the processor 210 may output a control signal to the electric movement system 154 that directly controls the position of electrode 112.

Electrode position controller 148 may be a programmable logic controller (PLC), for example, or an equivalent configurable computing device. Memory 220 is a non-volatile memory, such as flash memory or another form of read-only memory. Processor 210 may be a suitable microprocessor or microcontroller, digital signal processor or ASIC. Although not shown in FIG. 2, electrode position controller 148 has analog to digital and digital to analog conversion circuits for communicating with external devices that use analog signals.

Reactor controller 128 and electrode position controller 148 communicate via a dedicated communication cable 228. As reactor controller 128 receives the sensed parallel reactor current level from current transformer 129 and the primary supply voltage from voltage transformer 130, these varying parameters need to be reliably and continually transmitted to electrode position controller 148 for performance of the calculation and comparison functions, as described. As an alternative to having a dedicated communications cable 228, an alternative form of reliable and robust communication between reactor controller 128 and electrode position controller 148 may be employed. Such alternatives may include a wired or wireless connection, either dedicated or through a network.

In an alternative embodiment, if electrode position controller 148 directly receives the sensed parallel reactor current from current transformer 129, processor 210 may only need to communicate with reactor controller 128 to determine the primary supply voltage sensed at voltage transformer 130.

In an alternative embodiment, the calculation and comparison functions may be performed within reactor controller 128, instead of electrode position controller 148. In such an embodiment, reactor controller 128 would provide an output to electrode position controller 148 to indicate that the electrode 112 should be lowered if the parallel reactor current drops below the current threshold value. Electrode position controller 148 then provides an appropriate output to electrode movement system 154 to cause electrode 112 to be lowered.

According to the embodiment shown in FIG. 2, electrode position controller 148 continues to monitor the parallel reactor current sensed at current transformer 129, even after processor 210 has output a signal to electrode movement system 154 to cause electrode 112 to be lowered. Thus, processor 210 continues to cause electrode 112 to be lowered until the monitored parallel reactor current is at a level conducive to more effective control of the current in the power supply line by reactor controller 128. For example, a further current threshold value may be set for determining when to cease lowering electrode 112. This further current threshold value may have a direct relationship with the threshold value for initially determining whether to lower the electrode.

For purposes of clarity of description, we shall refer to the threshold used for determining whether to lower the electrode as an initiation threshold and the threshold used to determine whether to cease lowering the electrode as the cancellation threshold, regardless of the specific operating parameter that the threshold relates to. While the initiation threshold and the cancellation threshold may be chosen to be the same, in such a case it is possible that small variations of the operating parameter around the initiation threshold may spuriously trigger lowering or ceasing of the electrode 112. Accordingly, if the cancellation threshold is higher than the initiation threshold by a fixed proportion, for example, this may avoid such spurious lowering or ceasing of the electrode 112.

For a cancellation threshold higher than the initiation threshold, equation (1) above may be used to determine the current threshold value (where the operating parameter is a parallel reactor current), although a different, higher proportionality constant α is required. For example, if the initiation threshold for the current through parallel reactor 120 is set using a proportionality constant of 0.3 (i.e. 30% of the total expected current through variable reactor 118), the proportionality constant for the cancellation threshold may be set at a higher value, such as 0.35, 0.4 or 0.5.

Once electrode position controller 148 has caused electrode 112 to be lowered, and then ceases lowering electrode 112 because the relevant operating parameter has risen above the cancellation threshold, the electrode position controller 148 ceases to override the normal operation of control system 100 and allows electrode 112 to be further repositioned according to the programmed control paradigm for control system 100 and electrode position controller 148.

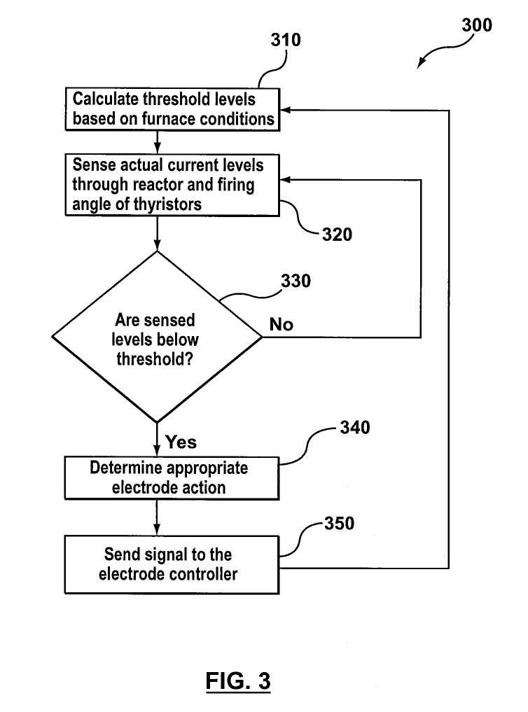

Referring now to FIG. 3, a flowchart of a method 300 of predictively controlling electrode movement is described. Method 300 begins at step 310, at which electrode position controller 148 (or reactor controller 128 in an alternative embodiment) calculates the applicable initiation and cancellation threshold levels for the chosen operating parameter of variable reactor 118, for example based on equation (1). Depending on the operating conditions of the furnace system, including the primary supply voltage V, the calculated thresholds may vary.

At step 320, one or more sensors in the variable reactor 118, such as current transformer 129, provide output to reactor controller 128 at step 320, thereby allowing reactor controller 128 to sense the actual current levels through parallel reactor 120 or current limiting reactor 123 or to sense the firing angle of the thyristors 122. Reactor controller 128 provides one or more signals to electrode position controller 148 corresponding to the received output of the relevant sensor coupled to a sub-circuit of variable reactor 118.

At step 330, electrode position controller 148 compares the sensed operating parameter levels (as received from the reactive controller 128 over communication cable 228) and compares them to the initiation threshold. If the sensed operating parameter is below the initiation threshold, then at step 340, the electrode position controller 148 determines that the electrode 112 should be lowered at step 350 and outputs a signal to electrode movement system 154 to cause the electrode 112 to be lowered. Otherwise, electrode position controller 148 continues to monitor the level of the operating parameter relative to the initiation threshold by repeating steps 320 to 330.

Once the electrode position controller 148 has output the signal to electrode movement system 154 at step 350, electrode position controller 148 may repeat performance of steps of 310 to 330 to determine when to cease lowering the electrode 112. Alternatively, electrode position controller 148 may skip repeating step 310 and monitor the relevant operating parameter relative to the cancellation threshold by repeating steps 320 to 330.

Once electrode position controller 148 determines that the operating parameter is no longer below the cancellation threshold (at step 330), it determines at step 340 that the appropriate electrode action is to cease lowering the electrode. Accordingly, electrode position controller 148 provides an appropriate output to electrode movement system 154 to cause it to cease lowering of electrode 112 and resume normal electrode position for regulation. Alternatively, processor 210 of electrode position controller 148 may simply discontinue providing the override command to cause electrode movement system 154 to lower electrode 112.

Method 300 is performed continuously during supply of power to the furnace 101 in order to enable reactor controller 128 to maintain control over current supply to electrode 112 from power supply 110. This greater control capability may mitigate the number and degree of power drops in the power supply to electrode 112 and thus bring the average power closer to the power set-point.

While the above description provides example of embodiments, it will be appreciated that some features and/or functions are susceptible to modification without departing from the spirit and principles of operation of the described embodiments. Accordingly, what has been described is intended to be illustrative of the invention and non-limiting.

1. A method of predictive electrode lowering in an electric furnace, comprising:
monitoring an operating parameter of a variable reactance circuit;
comparing the operating parameter with a threshold value; and
lowering an electrode coupled to the variable reactance circuit if the operating parameter meets or passes the threshold value.

2. The method of claim 1, wherein the variable reactance circuit is positioned in a power supply circuit intermediate a power supply and the electrode.

3. The method of claim 2, wherein a transformer is positioned in the power supply circuit intermediate the variable reactance circuit and the electrode.

4. The method of claim 1, wherein the monitoring comprises monitoring an operating parameter of a sub-circuit of the variable reactance circuit.

5. The method of claim 4, wherein the sub-circuit comprises a current-switching circuit.

6. The method of claim 5, wherein the current switching circuit comprises a pair of thyristors.

7. The method of claim 6, wherein the operating parameter is a gating angle of the thyristors.

8. The method of claim 7, wherein the threshold value is a gating angle value in the range between 80° and 170°.

9. The method of claim 4, wherein the sub-circuit comprises a parallel inductor.

10. The method of claim 9, wherein the operating parameter is a current through the parallel inductor.

11. The method of claim 10, wherein the threshold value is a current threshold value.

12. The method of claim 9, wherein the operating parameter is a voltage across the parallel inductor.

13. The method of claim 4, wherein the sub-circuit comprises a series reactor.

14. The method of claim 1, wherein the electric furnace is a multi-phase furnace and wherein the method is performed for each phase of the furnace.

15. The method of claim 1, wherein the electrode is part of an electrode pair for a power supply phase and the lowering comprises lowering the electrode pair.

16. The method of claim 1, wherein the electric furnace is an AC electric arc furnace.

17. The method of claim 1, wherein the threshold value is a first threshold value and further comprising monitoring the operating parameter during the lowering, comparing the operating parameter to a second threshold value and ceasing the lowering if the operating parameter exceeds the second threshold value.

18. The method of claim 17, wherein the second threshold value is higher than the first threshold value.

19. A method of predictive electrode lowering in an electric furnace, comprising:
monitoring current through a parallel inductor in a variable reactance circuit;
comparing the current with a current threshold; and
lowering an electrode coupled to the variable reactance circuit if the current is at or below the current threshold.

20. The method of claim 19, wherein the variable reactance circuit is positioned in a power supply circuit intermediate a power supply and the electrode.

21. The method of claim 20, wherein a transformer is positioned in the power supply circuit intermediate the variable reactance circuit and the electrode.

22. The method of claim 19 wherein the current threshold is determined based on at least one of: a predetermined proportion of an expected total current through the variable reactance circuit; a primary supply voltage; a rated reactance value of the parallel inductor; and a target power factor.

23. The method of claim 19, wherein the current threshold varies proportionally with a primary supply voltage of the electric furnace.

24. The method of claim 19, wherein the value of the current threshold is between about 10% to 60% of an expected total current through the variable reactance circuit.

25. The method of claim 19, wherein the electric furnace is a multi-phase furnace and wherein the method is performed for each phase of the furnace.

26. The method of claim 19, wherein the electrode is part of an electrode pair for a power supply phase and the lowering comprises lowering the electrode pair.

27. The method of claim 19, wherein the electric furnace is an AC electric arc furnace.

28. The method of claim 19, wherein the current threshold is a first current threshold and further comprising monitoring the current during the lowering, comparing the current to a second current threshold and ceasing the lowering if the current exceeds the second current threshold.

29. The method of claim 28, wherein the second current threshold is higher than the first current threshold.

30. A system for predictive lowering of an electrode in an electric furnace, comprising:
a variable reactance circuit electrically coupled to the electrode for regulating current to the electrode from a power supply;
a sensor for sensing an operating parameter of the variable reactance circuit; and
an electrode position controller configured to receive a sensor signal corresponding to the operating parameter from the sensor, to compare the operating parameter to a threshold value and to cause the electrode to be lowered if the operating parameter meets or passes the threshold value.

31. The system of claim 30, wherein the operating parameter is an operating parameter of a sub-circuit of the variable reactance circuit.

32. The system of claim 31, wherein the sub-circuit comprises a current-switching circuit.

33. The system of claim 32, wherein the current switching circuit comprises a pair of thyristors.

34. The system of claim 33, wherein the operating parameter is a gating angle of the thyristors.

35. The system of claim 34, wherein the threshold value is a gating angle value in the range between 80° and 170°.

36. The system of claim 31, wherein the sub-circuit comprises a parallel inductor.

37. The system of claim 36, wherein the operating parameter is a current through the parallel inductor.

38. The system of claim 37, wherein the threshold value is a current threshold value.

39. The system of claim 36, wherein the operating parameter is a voltage across the parallel inductor.

40. The system of claim 31, wherein the sub-circuit comprises a series reactor.

41. The system of claim 30, wherein the electric furnace is a multi-phase furnace and wherein the system is used for each phase of the furnace.

42. The system of claim 30, wherein the electrode is part of an electrode pair for a power supply phase and the electrode position controller causes the electrode pair to be lowered.

43. The system of claims 30, wherein the electric furnace is an AC electric arc furnace.

44. The system of claim 30, wherein the threshold value is a first threshold value and wherein the electrode position controller is further configured to monitor the operating parameter during lowering of the electrode, compare the operating parameter to a second threshold value and to cease the lowering if the operating parameter exceeds the second threshold value.

45. The system of claim 44, wherein the second threshold value is higher than the first threshold value.

46. A system for predictive lowering of an electrode in an electric furnace, comprising:
a variable reactance circuit electrically coupled to the electrode for regulating current to the electrode from a power supply, the variable reactance circuit having a parallel inductor;
a sensor for sensing a current through the parallel inductor; and
an electrode position controller configured to receive a sensor signal corresponding to the current from the sensor, to compare the current to a current threshold and to cause the electrode to be lowered if the current is at or below the current threshold.

47. The system of claim 46, wherein the electrode position controller is further configured to calculate the current threshold based on at least one of: a predetermined proportion of an expected total current through the variable reactance circuit; a primary supply voltage; a rated reactance value of the parallel inductor; and a target power factor.

48. The system of claim 46, wherein the current threshold varies proportionally with a primary supply voltage of the electric furnace.

49. The system of claim 46, wherein the value of the current threshold is between about 10% to 60% of an expected total current through the variable reactance circuit.

50. The system of claim 46, wherein the current threshold is a first current threshold and the electrode position controller is further configured to monitor the current during lowering of the electrode, to compare the current to a second current threshold and to cease the lowering if the current exceeds the second current threshold.

51. The system of claim 50, wherein the second current threshold is higher than the first current threshold.

52. The system of claim 46, wherein the electric furnace is a multi-phase furnace and wherein the system is used for each phase of the furnace.

53. The system of claim 46, wherein the electrode is part of an electrode pair for a power supply phase and the electrode position controller is configured to cause the electrode pair to be lowered.

54. The system of claim 46, wherein the electric furnace is an AC electric furnace.

55. Computer readable storage storing program instructions which, when executed by one or more processors in a furnace system, cause the furnace system to:
monitor an operating parameter of a variable reactance circuit in the furnace system;
compare the operating parameter with a threshold value; and
lower an electrode coupled to the variable reactance circuit if the operating parameter meets or passes the threshold value.

56. Computer readable storage storing program instructions which, when executed by one or more processors in a furnace system, cause the furnace system to:
monitor current through a parallel inductor in a variable reactor circuit in the furnace system;
compare the current with a current threshold; and
lower an electrode coupled to the variable reactance circuit if the current is at or below the current threshold.
